(19) United States
(12) Patent Application Publication
(10) Pub. No.: US 2013/0258103 A1
(43) Pub. Date: Oct. 3, 2013

(54) PORTABLE RACKING DEVICE WITH SLIDING ANTI-TORQUE TANG FOR DRAWOUT POWER CIRCUIT BREAKERS

(71) Applicant: MARTEK LIMITED, Charleston, WV (US)

(72) Inventors: Charles M. McClung, Elkview, WV (US); Russell R. Safreed, III, St. Albans, WV (US)

(73) Assignee: MarTek Limited, Charleston, WV (US)

(21) Appl. No.: 13/848,179

(22) Filed: Mar. 21, 2013

Related U.S. Application Data
(60) Provisional application No. 61/617,933, filed on Mar. 30, 2012.

(51) Int. Cl. H01H 3/22; H04N 7/18

(52) U.S. Cl. CPC H01H 3/227; H04N 7/18
USPC 348/143; 200/331; 307/140; 348/739

(57) ABSTRACT

A portable motorized device for remotely inserting or removing (racking) screws for draw-out power circuit breakers. Many different designs of draw-out circuit breakers may be connected or disconnected from an energized bus by a human operator cranking a jack screw mechanism that is part of the breaker. The device herein described provides a portable, motorized device that can be hand-carried to the work location and affixed to the circuit breaker without the need of any modification to the breaker or its enclosure. The torque that is required to operate the breaker's racking mechanism is provided by an electrically powered gear motor. Attached to the output shaft of the gear motor is a socket that engages the circuit breaker racking screw. Anti-torque is provided by a portion of the portable racking device that engages the racking screw ‘window’. The friction created by the torque of the socket against the racking screw and the racking device engaging the racking screw window.

### CLAIM OF PRIORITY

This application claims priority to co-pending U.S. Provisional Application 61/617,933 entitled “Portable Racking Device With Sliding Anti-torque Tang for Drawout Power Circuit Breakers” and filed on Mar. 30, 2012, which is incorporated herein by reference.

### BACKGROUND OF THE INVENTION

In larger power systems, a typical draw-out circuit breaker is connected to or disconnected from the energized bus for maintenance or repair by a human operator who physically rotates a racking screw in order to connect or disconnect the breaker from the electrical supply bus. In order to effect the operation described above, a human operator must stand within arms-reach of the circuit breaker, which also means he or she is in close proximity to the circuit breaker. If the circuit breaker should happen to fail catastrophically, the human operator is at risk of serious injury or death from the resulting arc-blast and flying debris.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles in the disclosure. Moreover, in the drawings, like reference numerals designate corresponding parts throughout the several views.

FIG. 1 is an illustrative example of a circuit breaker shown with the portable actuator engaged, according to the various embodiments of the present disclosure.

FIG. 2A, shows the location of a magnified region of the draw-out circuit that is depicted in FIGS. 2B and 2C.

FIG. 2B is a close-up view of the breaker racking screw window with the breaker racking screw window access shutter in the closed position.

FIG. 2C is a close-up view of the breaker racking screw window with the breaker racking screw window access shutter in the open position, revealing the racking screw.

FIG. 3 depicts the racking actuator depressing the racking screw window shutter.

FIG. 4A shows the sectional view of the draw-out circuit breaker that is depicted in FIGS. 4B and 4C.

FIG. 4B is a sectional view of the portable racking device depressing the circuit breaker racking screw access window shutter.

FIG. 4C is a sectional view of the portable racking device fully engaging the circuit breaker racking screw and the anti-torque device is fully engaging the circuit breaker racking screw access window.

FIG. 5A is a top view of the anti-torque device position when the circuit breaker racking screw is located to the left of center in the circuit breaker racking screw access window.

FIG. 5B is an end view of the anti-torque device when the circuit breaker racking screw is located to the left of center in the circuit breaker racking screw access window.

FIG. 5C is a top view of the anti-torque device position when the circuit breaker racking screw is located to the left of center in the circuit breaker racking screw access window.

FIG. 5D is an end view of the anti-torque device when the circuit breaker racking screw is located to the left of center in the circuit breaker racking screw access window.

FIG. 5E is a top view of the anti-torque device position when the circuit breaker racking screw is located to the left of center in the circuit breaker racking screw access window.

FIG. 5F is an end view of the anti-torque device when the circuit breaker racking screw is located to the left of center in the circuit breaker racking screw access window.

FIG. 6A is a partial exploded perspective view of the anti-torque device assembly.

FIG. 6B shows the three major components of the anti-torque device.

FIG. 7 is an exploded view of the ant-torque device assembly in relation to the gearmotor.

FIG. 8 depicts the portable racking actuator system; actuator, carrying case with power supply, and remote control station.

### DETAILED DESCRIPTION

The present disclosure details a portable device that facilitates the remote racking of draw-out power circuit breakers by means of a portable electrically driven racking device. The portable actuating device is easily affixed to the circuit breaker without the need of permanently modifying the circuit breaker or the enclosure of the circuit breaker. The portable racking device is small enough to be stored and transported in a hand-held carrying case.

In some embodiments of the present disclosure, the portable racking device may comprise an electrically-driven motor and gearbox, power supply and circuitry necessary to run the electric motor bi-directionally while monitoring the output torque of the gear motor. A video camera, attached to the racking device allows the human operator to visually monitor the position and progress of the breaker while it is being racked, by viewing a video screen that is contained in the remote hand-held control station.

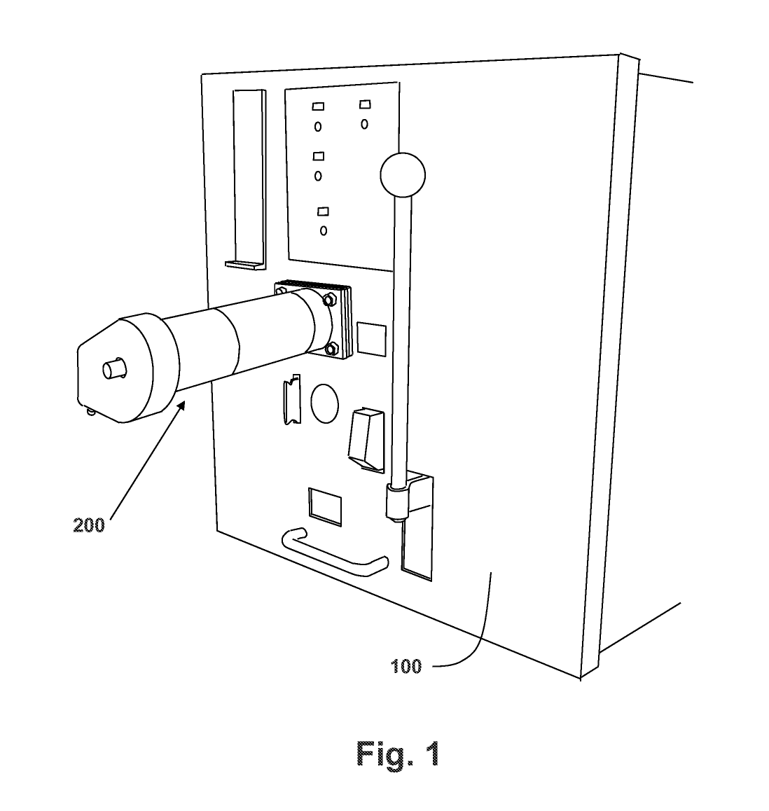

With reference to FIG. 1, the portable racking actuator 200 may be attached to a typical draw-out circuit breaker 100 as shown, for racking the breaker onto the bus, or racking the breaker off of the bus. In some embodiments of the present disclosure, the portable racking actuator 200 may attach directly to an external or front faceplate of the draw-out circuit breaker 100. In other embodiments of the present disclosure, the portable racking actuator may attach to the underlying structure, frame, or skeleton of the circuit breaker after the external or front faceplate has been removed.

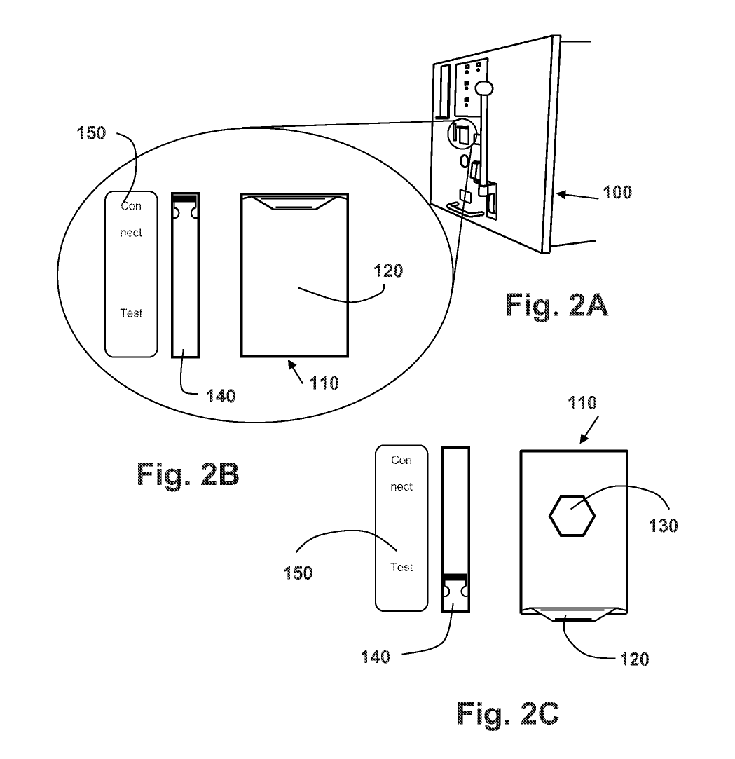

With reference to FIG. 2A, a magnified region of the draw-out circuit breaker 100 is shown, which depicts a typical breaker racking screw access window 110, breaker racking screw access window shutter 120, and corresponding breaker position indicator 140 and position indicator label 150, showing the breaker in the ‘Connect’ position. Such an example is illustrative, as various circuit breakers 100 may arrange the breaker racking screw access window 110, breaker racking screw access window shutter 120, and corresponding breaker position indicator 140 in different configurations or positions.

FIG. 2B depicts an enlarged section of the circuit breaker 100, for the purpose of identifying the location and relationship of the circuit breaker racking screw window 110, the circuit breaker racking screw access window shutter 120, the circuit breaker position indicator 140, and the circuit breaker position indicator label 150. For illustrative purposes only, the circuit breaker racking screw access window shutter 120 is closed or shuttered.

FIG. 2C shows the circuit breaker racking screw access window shutter 120 in the open position, revealing the breaker racking screw 130, and the breaker position indicator 140 in the ‘Remove’ position.

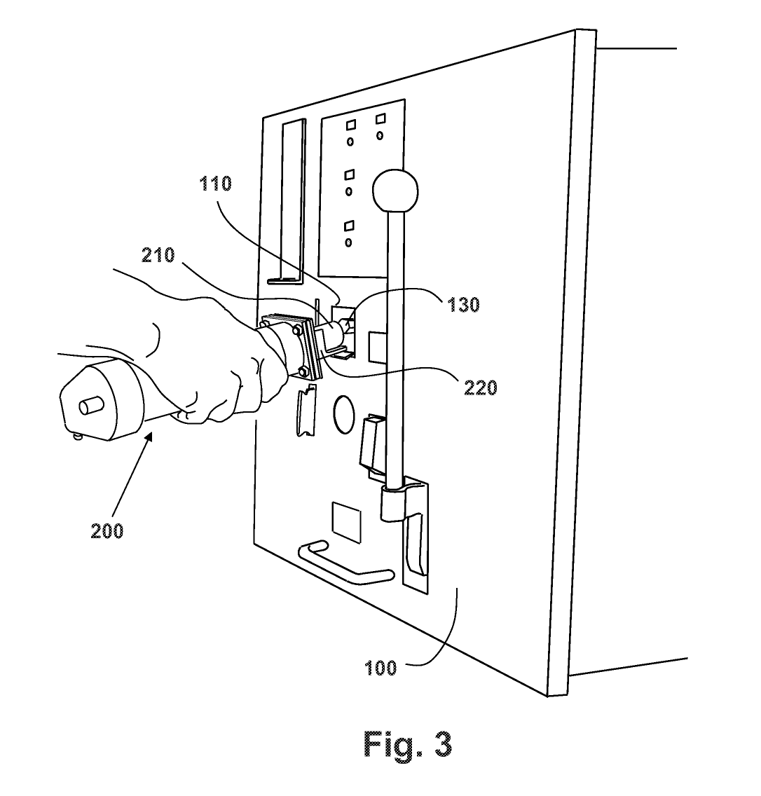

FIG. 3 depicts one embodiment of the present disclosure, wherein the portable racking actuator 200 is attached to the breaker 100 by using the anti-torque device 220 to open the breaker racking screw access window shutter and engaging the drive socket 210 of portable racking device with breaker racking screw 130. As the drive socket 210 is rotated by the mechanical force produced by the portable racking device 200, the breaker is moved onto, or off of, the bus. The anti-torque device 220 prevents the portable racking actuator 200 from rotating as a result of the torque generated by the portable racking device 200 applied to the drive socket 210 when affixed to the circuit breaker racking screw window 110.

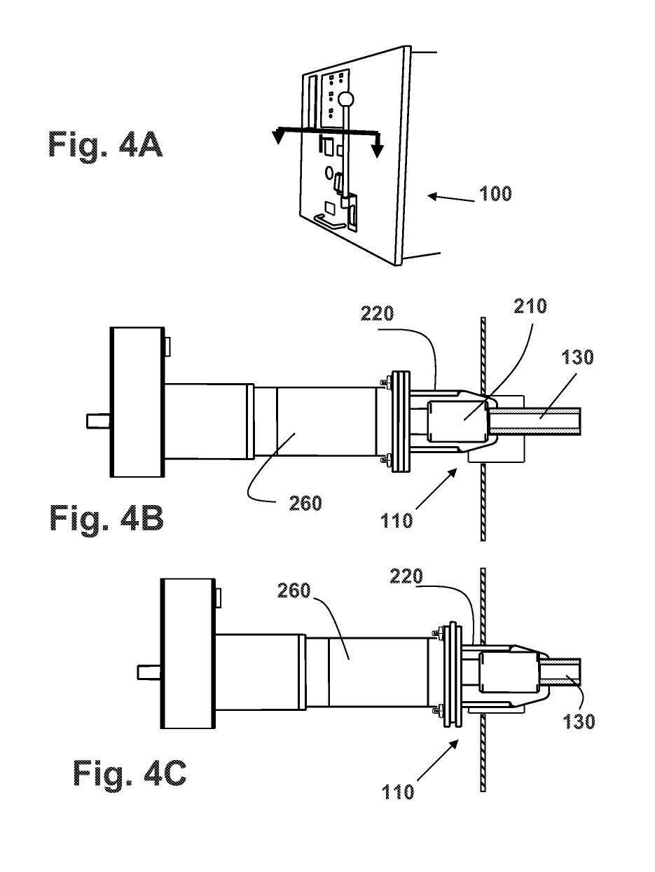

Proceeding to FIG. 4A shown is a front plate and control interface for the circuit breaker 100 as a reference for the depictions of the disclosure in FIG. 4B and FIG. 4C. A bar with arrows is drawn across FIG. 4A to indicate the direction of the cross sectional views to be depicted in FIG. 4B and FIG. 4C.

With reference to FIG. 4B, which is a sectional view of the circuit breaker 100 as indicated in FIG. 4A, the portable racking actuator anti-torque device 220 is shown depressing the circuit breaker racking screw access window shutter 120 and the drive socket 210 is beginning to engage the breaker racking screw window 110.

Referring now to FIG. 4C, the portable racking actuator 200 is pushed toward the circuit breaker racking screw 130 in order to fully engage the drive socket 210 while the anti-torque device 220 engages the sides of the circuit breaker racking screw access window 110. The breaker racking screw 130 may not be centered in the breaker racking screw access window 110, as is depicted in FIG. 4B. As shown in FIG. 4C, the side of the anti-torque contacts the side of the breaker racking screw access window 110. As the portable racking actuator 200 is pushed toward the circuit breaker racking screw access window 110, fully engaging the portable racking device drive socket 210, the anti-torque device 220 is slid to the side relative to the drive socket 210 in order to align with and engage the breaker racking screw access window 110.

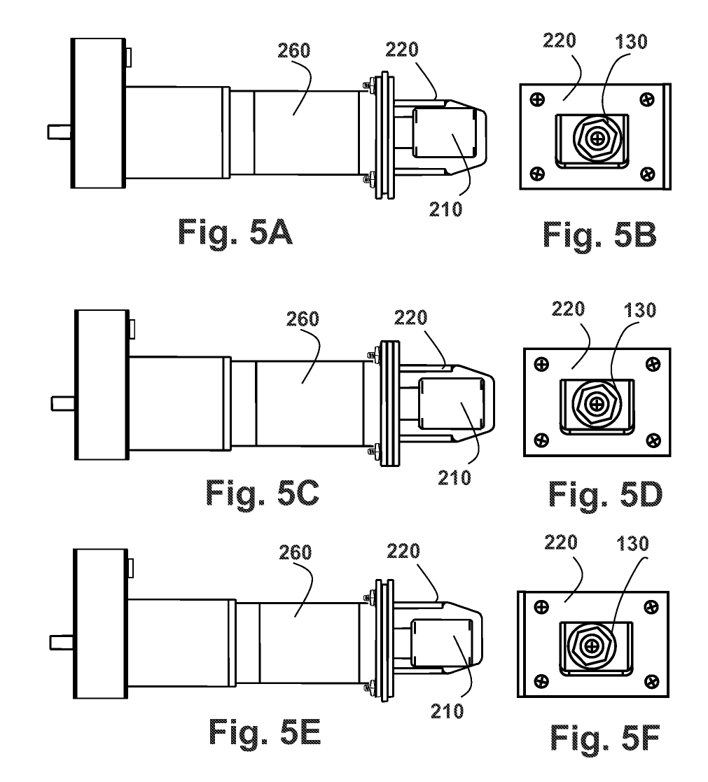

Proceeding to FIG. 5A, shown is a side-view of various embodiments of the present disclosure to further clarify the operation of the anti-torque device 220. As depicted in the side view, the drive socket 210 is off-center with respect to the anti-torque device 220 due to the circuit breaker racking screw 130 being off center with respect to the circuit breaker racking screw window 110 (FIG. 2C).

Moving on to FIG. 5B, presented is a cross-section view from the front of the gear motor 260 and anti-torque device 220 depicting the anti-torque device 220 slid to one side, relative to the portable racking device drive socket 210, in order to accommodate a circuit breaker racking screw 130 that is to the left of center with respect to the circuit breaker racking screw window 110 (FIG. 2C).

Referring next to FIG. 5C, shown is a side-view of various embodiments of the present disclosure to further clarify the operation of the anti-torque device 220. As depicted in the side view, the drive socket 210 is centered with respect to the anti-torque device 220 due to the circuit breaker racking screw 130 being centered with respect to the circuit breaker racking screw window 110 (FIG. 2C).

Moving on to FIG. 5D, presented is a cross-section view from the front of the gear motor 260 and anti-torque device 220 depicting the anti-torque device 220 centered, relative to the portable racking device drive socket 210, in order to accommodate a circuit breaker racking screw 130 that is centered with respect to the circuit breaker racking screw window 110 (FIG. 2C).

Proceeding to FIG. 5E, shown is a side-view of various embodiments of the present disclosure to further clarify the operation of the anti-torque device 220. As depicted in the side view, the drive socket 210 is off-center with respect to the anti-torque device 220 due to the circuit breaker racking screw 130 being off center with respect to the circuit breaker racking screw window 110 (FIG. 2C).

Referring next to FIG. 5F, presented is a cross-section view from the front of the gear motor 260 and anti-torque device 220 depicting the anti-torque device 220 slid to one side, relative to the portable racking device drive socket 210, in order to accommodate a circuit breaker racking screw 130 that is to the right of center with respect to the circuit breaker racking screw window 110 (FIG. 2C).

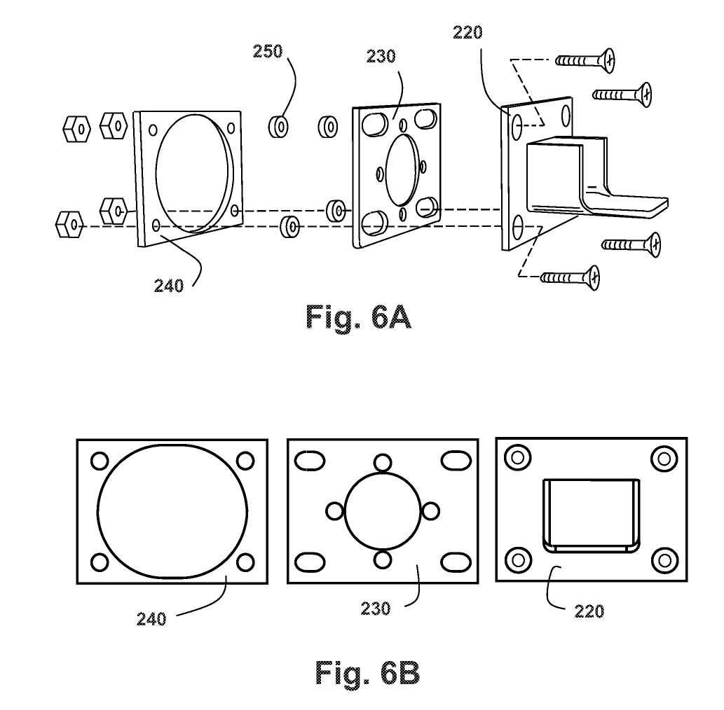

Proceeding to FIG. 6A, an exploded perspective view is shown of the anti-torque device 220 into its three major components according to various embodiments of the present disclosure. Moving from right to left, shown is an anti-torque device 220 for manipulating a circuit breaker racking screw access window shutter 120 (FIG. 2B, FIG. 2C) and engaging with a circuit breaker racking screw window 110. The anti-torque device 220 is coupled to a slide support 230 with a plurality of screws. Various embodiments of the present disclosure may use other fasteners and a different number of fasteners than those depicted in FIG. 6A. The slide support 230 is coupled to an anti-torque backing plate 240, with slide spacers 250 between the slide support 230 and the anti-torque backing plate 240.

Moving on to FIG. 6B, the three major components of the anti-torque device 220 are show from a front facing perspective. Four elongated holes are positioned toward the corners of the slide support 230. A slide spacer 250 (FIG. 6A) fits inside each of the four elongated holes in the slide support 230 and may move laterally inside the elongated holes. The slide spacers 250 are slightly thicker than the thickness of the slide support 230, and act as a spacer to ensure the anti-torque device 220 and anti-torque backing plate 240 can slide freely from side-to-side.

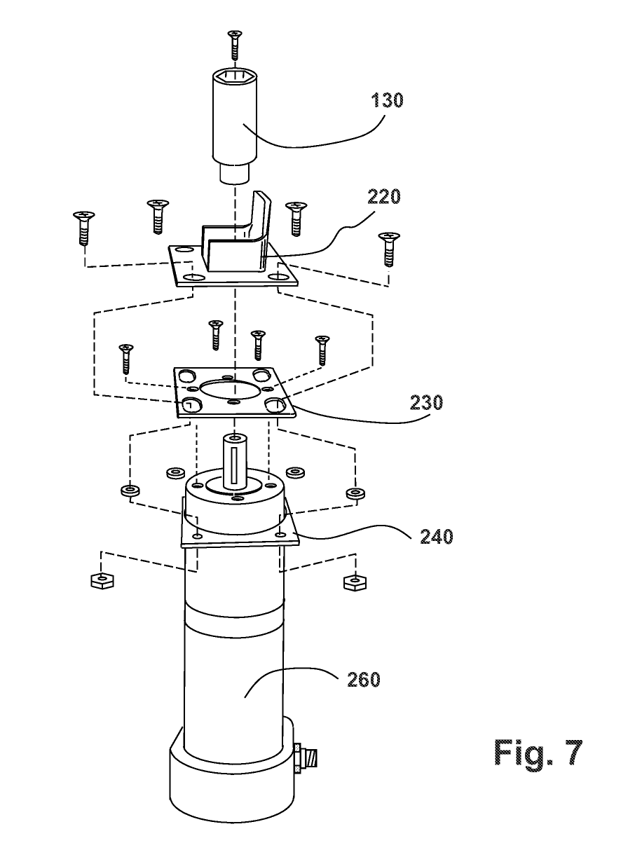

Referring next to FIG. 7, a partial exploded view of the portable racking device 220 is shown. The slide support 230 is securely fastened to the end of the gear motor 260. The anti-torque device 220, slide spacers 250, and anti-torque backing plate 240 are held firmly together by four screws. The center hole in the anti-torque device backing plate 240 is elongated to facilitate lateral movement with regard to the gear motor 260. The drive socket 210 fits on the output shaft of the gear motor 260.

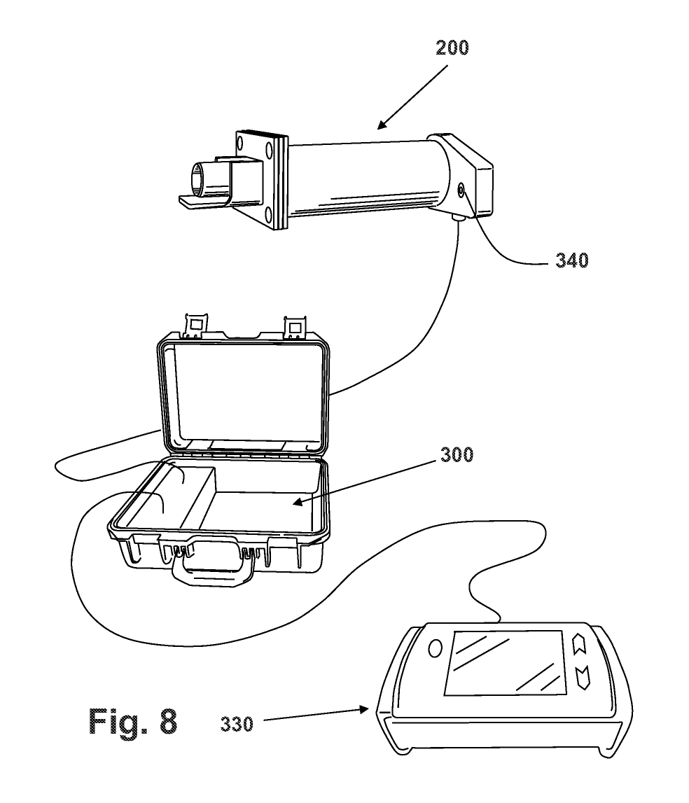

Moving on to FIG. 8, the major components of the system—the portable racking actuator 200, the carrying case/power supply 300 and the hand-held control station 330—are depicted in relationship to each other. The closed-circuit video camera 340 is mounted on the portable racking actuator 200 and is aimed to view the breaker position indicator 150, as depicted in FIG. 3B. The image of the breaker position indicator 150 (FIG. 2B) is displayed on the hand-held control station 330.

We claim:

1. A portable, motorized device for remotely racking a drawout circuit breaker, the portable, motorized device comprising:
a motor and a gear box operatively attached to a drive socket for engaging a breaker racking screw; and
an anti-torque device affixed to the motor, the anti-torque device configured to:
engage the breaker racking screw access window, whereby at least one plane of the anti-torque device is substantially parallel with at least one plane of the breaker racking screw access window; and
slide substantially perpendicular to an axis of the drive socket to allow for misalignment of the breaker racking screw with respect to the breaker racking screw access window.

2. The portable, motorized device of claim 1, wherein the motor comprises an alternating current motor.

3. The portable, motorized device of claim 1, wherein the motor comprises a brushed direct current motor.

4. The portable, motorized device of claim 1, wherein the motor comprises a brushless direct current motor.

5. The portable, motorized device of claim 1, wherein the anti-torque device is moveable in relation to the drive socket along another plane that lies substantially perpendicular to the motor output shaft to allow for misalignment between the breaker racking screw and the breaker racking screw access window.

6. The portable, motorized device of claim 1, wherein the anti-torque device comprises a rectangular shape.

7. The portable, motorized device of claim 1, wherein the anti-torque device comprises an ‘L’ shape.

8. The portable, motorized device of claim 1, wherein the anti-torque device comprises a polygon.

9. The portable, motorized device of claim 1, wherein the anti-torque device comprises a flat tang.

10. The portable, motorized device of claim 1, wherein the drive socket fits a breaker racking screw comprising of a hexagonal shape.

11. The portable, motorized device of claim 1, wherein the drive socket fits a breaker racking screw comprising of a square shape.

12. The portable, motorized device of claim 1, where the anti-torque device is tapered on at least two opposing sides to facilitate aligning the anti-torque device as the anti-torque device is inserted into the breaker racking screw access window.

13. A system for operating a portable racking device with a sliding anti-torque device adapted to engage a drawout power circuit breaker, the system comprising:
a video monitor communicatively coupled to a portable case; and
a handheld control device communicatively coupled to the portable case; and
the portable case electrically connected and communicatively coupled to the portable racking device, the portable case comprising:
a power supply; and
a circuit, a processor, or a combination thereof that is configured to receive, process and relay signals from the portable racking device to the video monitor or the handheld control device.

14. The system of claim 13, wherein the portable racking device further comprises a closed circuit video camera, the closed circuit video camera communicatively coupled to the portable case oriented to face a circuit breaker engaged by the portable racking device.

15. The system of claim 14, wherein the closed circuit video camera communicates a video feed to the circuit, processor, or the combination thereof, the circuit, processor, or combination thereof relaying the video feed to the video monitor.

16. The system of claim 13, wherein the portable racking device further comprises a motor current sensor, the motor current sensor relaying to the processor, circuit, or combination thereof the amount of torque being applied to the racking mechanism by the portable racking device.

17. The system of claim 16, wherein the circuit, processor, or combination thereof relays the motor current measurement value to the video monitor.

18. The system of claim 17, wherein the video monitor displays the motor current measurement value.

19. The system of claim 13, wherein the portable racking device further comprises a shaft encoder, the shaft encoder coupled to a motor of the portable racking device and determining a distance and a direction a breaker has moved, as a function of a number of revolutions of a breaker racking screw.

20. A system, comprising:
a portable, motorized actuator comprising:
an actuator frame configured to engage to an external faceplate of a circuit breaker and align with a breaker racking screw access window; and
an anti-torque device comprising:
a tang configured to manipulate a breaker racking screw access window shutter;
a coupler configured to engage a breaker racking screw access window; and
a plurality of sliders permitting lateral movement with respect to the anti-torque device of a drive socket extending from the portable motorized actuator within the anti-torque device; and
a remote controller configured to provide a plurality of signals to the portable, motorized actuator.
